(19) United States
(12) Patent Application Publication
(10) Pub. No.: US 2025/0347798 A1
(43) Pub. Date: Nov. 13, 2025

(54) Method with a Radar Device and Radar Device

(71) Applicant: KROHNE S.A.S., Romans-sur-Isère Cedex (FR)

(72) Inventor: Olivier Dubray, Chatuzange-Le-Goubet (FR)

(73) Assignee: KROHNE S.A.S., Romans-sur-Isère Cedex (FR)

(21) Appl. No.: 19/202,350

(22) Filed: May 8, 2025

(30) Foreign Application Priority Data
May 8, 2024 (DE) 102024113005.9

(51) Int. Cl. G01S 13/32; G01S 7/35

(52) U.S. Cl. CPC G01S 13/32; G01S 7/356

(57) ABSTRACT

A method for determining a distance between a radar device and an object includes: generating and emitting a frequency-modulated emission signal, receiving a reflection signal, and mixing the emission signal and the reflection signal with one another to form a mixed signal; determining a coarse frequency spectrum of the mixed signal in a coarse frequency range, a spectral maximum in the coarse frequency spectrum, and a coarse spectral maximum frequency of the spectral maximum in the coarse frequency range; determining, a frequency range and a number of spectral frequencies in the frequency range; determining, using a chirp Z-transform, a fine frequency spectrum of the mixed signal in the frequency range with the number of spectral frequencies; determining a fine spectral maximum frequency of a spectral maximum in the frequency range; and determining a distance between the radar device and the object using the fine spectral maximum frequency.

### BACKGROUND OF THE INVENTION

### Field of the Invention

The invention relates to a method with a radar device for determining a distance between the radar device and an object by means of frequency-modulated continuous wave radar. The invention further relates to a radar device for determining a distance between the radar device and an object by means of frequency-modulated continuous wave radar.

### Description of Related Art

A radar device is generally a device which, during operation, generates and emits an emission signal, receives a reflection signal caused by the emission signal at an object and performs an evaluation of the reflection signal and/or the emission signal. The reflection signal is an echo of the emission signal on the object. The emission signal and consequently also the reflection signal are electromagnetic waves with frequencies in a radar frequency range. The evaluation provides at least one piece of information about the object. The information is, for example, a distance or a speed between the radar device and the object.

In any case, a radar device has an antenna device and a controller. The antenna device has either an antenna for transmitting the emission signal and for receiving the reflection signal or a transmitter antenna for transmitting the emission signal and a receiver antenna for receiving the reflection signal. The controller is designed to generate the emission signal and transmit it via the antenna device and to receive the reflection signal via the antenna device and to perform an evaluation of the reflection signal and/or the emission signal.

The method and the radar device relate to a frequency-modulated continuous wave radar. Accordingly, one frequency of the emission signal is modulated. It is therefore not a pulse radar or an unmodulated continuous wave radar. Frequency-modulated continuous wave radar is also abbreviated to FM CW radar. The abbreviation stands for frequency modulated continuous wave radar.

In a generic method performed by a generic radar device during operation, the following method steps are carried out:
A frequency-modulated emission signal is generated and transmitted via the antenna device.
A reflection signal caused by the emitted emission signal at an object is received via the antenna device.
The emission signal and the reflection signal are mixed together to form a mixed signal and a frequency spectrum of the mixed signal is determined. The mixed signal has a beat frequency.
A spectral maximum in the frequency spectrum and a spectral maximum frequency of the spectral maximum are determined. The beat frequency is essentially determined by the spectral maximum and the spectral maximum frequency.
A distance between the radar device and the object is determined using the spectral maximum frequency. The spectral maximum frequency corresponds to the distance.

These and other method steps are always performed by the controller. Method steps are abbreviated as steps in the following.

Itis known from the state of the art to determine the frequency spectrum of the mixed signal using a Fast Fourier Transform. Fast Fourier transform is abbreviated as FFT.

Fourier coefficients Sₖ of the FFT are determined according to the following formula:

$${S}_{k} = {\sum }_{n = 0}^{N - 1} {s}_{n} {e}^{- 2 π j \frac{n}{N} k} with k = 0 , 1 , 2 , … , N - 1$$

In the above formula, sₙ are time-discrete measured values of the mixed signal. These are measured by the controller. N is the number of measured values.

The Fourier frequencies fₖ associated with the Fourier coefficients Sₖ are determined according to the following formula:

$${f}_{k} = \frac{k}{N} {f}_{s} with k = 0 , 1 , 2 , … , \frac{N}{2}$$

In the formula, fₛ is a sampling frequency with which the measured values sₙ are sampled by the controller in discrete time.

A Fourier coefficient Sₖ at its associated Fourier frequency fₖ represents a spectral line. A spectral frequency step of two consecutive spectral lines is Δf=fs/N. The spectral line with the lowest Fourier frequency results for k=0 and lies at a lower limit frequency f_{min,FFT}=f₀=0 and the spectral line with the highest Fourier frequency results for k=N/2 and lies at an upper limit frequency of fmax,FFT=f_{N/2}=fs/2.

The frequency spectrum thus ranges from the lower limit frequency f_{min,FFT} to the upper limit frequency f_{max,FFT} and is formed by the spectral lines, wherein each spectral line is characterized by a Fourier coefficient Sₖ and a Fourier frequency fₖ. It always has the shape of a Gaussian bell curve above the frequency. The frequency spectrum formed by the FFT has a number of 1+N/2 spectral lines.

The spectral maximum frequency of the spectral maximum is determined with an accuracy of the spectral frequency step Δf. Often the accuracy of the determination of the spectral maximum frequency and thus also of the distance between the radar device and the object determined using the spectral maximum frequency is not sufficiently accurate for an application. However, the accuracy of determining the spectral maximum frequency can be improved by various methods. The accuracy is improved if the determined spectral maximum frequency is closer to the actual spectral maximum frequency. The actual spectral maximum frequency is the frequency at which the spectral maximum occurs.

According to one such method, interpolation is performed between spectral lines and the spectral maximum frequency is determined with greater accuracy using the interpolation.

According to another method, zeros are added to the measured values before determining the frequency spectrum in order to reduce the spectral frequency step Δf. The added zeros are evaluated as measured values and thus also increase N. Due to the reduced spectral frequency step, the determined maximum spectral frequency has greater accuracy. Methods in which the number of measured values of the mixed signal used to determine the frequency spectrum is increased are not considered here.

According to another method, the frequency spectrum of the mixed signal is determined using a chirp Z-transform. The chirp Z-transform is abbreviated as CZT.

Fourier coefficients Sₖ of the CZT are determined according to the following formula:

$${S}_{k} = {\sum }_{n = 0}^{N - 1} {s}_{n} {A}^{- n} {W}^{nk} with k = 1 , 2 , … , M - 1$$

Alternatively, Fourier coefficients Sₖ of the CZT can also be calculated according to the following formula:

$${S}_{k} = {W}^{\frac{{k}^{2}}{2}} {\sum }_{n = 0}^{N - 1} {s}_{n} {A}^{- n} {W}^{\frac{{n}^{2}}{2}} {W}^{- \frac{{( k - n )}^{2}}{2}} with k = 0 , 1 , 2 , … , M - 1$$

In the two formulas above, sₙ is again the discrete-time measured values of the mixed signal and N is again the number of measured values. M is the number of Fourier frequencies. It can be selected and is specified, for example.

A in the above formula is determined according to the following formula:

$$A = {e}^{2 π j \frac{{f}_{min}}{{f}_{S}}}$$

W in the above formula is determined according to the following formula:

$$W {=}^{- 2 π j \frac{1}{M} \frac{{f}_{max} - {f}_{min}}{{f}_{S}}}$$

fₘᵢₙ is a lower and fₘₐₓ is an upper limit frequency of the frequency spectrum. Compared to the other methods described for increasing the accuracy of determining the spectral maximum frequency from an FFT, this method provides the highest increase in accuracy.

A disadvantage of the generic method described above is a high energy requirement of the radar device for determining the distance between the radar device and the object when performing the method if an application requires the highest possible accuracy in determining the maximum spectral frequency and therefore the method described above is implemented by the radar device using the CZT.

### SUMMARY OF THE INVENTION

The object of the present invention is thus the specification of a generic method and a generic radar device, in which the energy requirement for determining the distance during performance of the inventive method is reduced without the accuracy of the determination of the distance being impaired.

The object is achieved by an inventive method that modifies the generic method and thus also constitutes a frequency-modulated continuous wave radar. In various embodiments, the inventive method has the following steps:

In a first step, the following sub-steps are performed:
Generating and emitting a frequency-modulated emission signal.
Receiving a reflection signal caused by the emission signal at the object.
Mixing the emission signal and the reflection signal together to form a mixed signal.

In a second step, the following sub-steps are performed:
Determining a coarse frequency spectrum of the mixed signal in a coarse frequency range.
Determining a spectral maximum in the coarse frequency spectrum.
Determining a coarse spectral maximum frequency of the spectral maximum in the coarse frequency range.

In a third step, a frequency range and a number of spectral frequencies in the frequency range are determined taking into account the coarse spectral maximum frequency. A quotient of the frequency range and the number results in a target spectral frequency step. The coarse spectral maximum frequency lies in the frequency range and the frequency range is smaller than the coarse frequency range. Preferably, the frequency range is as close as possible to the coarse spectral maximum frequency.

In a fourth step, a fine frequency spectrum of the mixed signal is determined in the frequency range with the number of spectral frequencies using a chirp Z-transform. In contrast to the FFT, the CZT allows both the frequency range and the number of spectral frequencies in the frequency range to be selected independently of the number of measured values.

In a fifth step, a fine spectral maximum frequency of the spectral maximum in the frequency range is determined. This is determined with an accuracy of the target spectral frequency step. The target spectral frequency step is specified, for example, depending on an application.

In a sixth step, a distance between the radar device and the object is determined using the fine spectral maximum frequency. Preferably, the distance is displayed to a user.

In embodiments, a radar device performing the inventive method comprises a controller and an antenna device. In embodiments, the steps of the inventive method are performed by the controller, wherein the emitting of the emission signal and the receiving of the reflection signal from the controller is performed via the antenna device, as described above.

In comparison with the method described in the prior art, which also uses the CZT, the energy requirement of the radar device is lower when the inventive method is performed, without impairing the accuracy of determining the distance. The lower energy requirement results from only using CZT in the frequency range, which is smaller than the coarse frequency range. This reduction of the energy requirement of the radar device without impairing the accuracy of determining the distance constitutes an improvement in the technology of radar devices that are used for determining a distance between the radar device and an object.

The inventive method can be designed and further developed in various ways. These steps are also performed by the radar device, preferably by the controller.

In a first design of the inventive method, the first step is initially performed again. Then, in one step, a frequency range and a number of spectral frequencies in the frequency range are determined again, taking into account the previously determined fine spectral maximum frequency. A quotient of the frequency range and the number again results in the target spectral frequency step. This step is a modified third step in which the previously determined fine spectral maximum frequency is taken into account instead of the coarse spectral maximum frequency. In particular, the fine spectral maximum frequency is taken into account in such a way that it lies within the frequency range. Then the fourth step is performed again. A spectral maximum is then searched for in the fine frequency spectrum. If a spectral maximum has been found, a fine spectral maximum frequency of the spectral maximum in the fine frequency spectrum is determined and the sixth step is performed again.

It is advisable to perform this design of the inventive method continuously. In a continuous implementation, the distance between the radar device and the object is also determined continuously, i.e. updated at regular intervals. The second step is not performed, so a coarse frequency spectrum is not determined again. Consequently, only the CZT is used in the frequency range, which further reduces the energy requirement.

If a spectral maximum is not found in this design, there are several alternative designs for finding one after all.

In a first of the alternative designs, the first step is first performed again. Then, in one step, a frequency range and a number of spectral frequencies in the frequency range are determined again, taking into account the previously determined fine spectral maximum frequency. Preferably, the frequency range is greater than the previously determined frequency range. A quotient of the frequency range and the number results in a spectral frequency step greater than the target spectral frequency step. This step is a modified third step in which, in particular, the quotient does not result in the target spectral frequency step, but is greater. The fourth step is then performed again. A spectral maximum is then searched for in the fine frequency spectrum. If a spectral maximum is found, a fine spectral maximum frequency of the spectral maximum in the frequency range is determined and the third, fourth, fifth and sixth steps are performed again. By performing the third, fourth, fifth and sixth steps again, the target spectral frequency step is set again and the distance is determined with the accuracy of the target spectral frequency step.

In a further development of the above design, if a spectral maximum is again not found, the steps according to the above design are performed again. Preferably, the frequency range is increased.

In a second of the alternative designs, the first step is first performed again. Then, taking into account the previously determined fine spectral maximum frequency, on the one hand a frequency range deviating from the previously determined frequency range and on the other hand a number of spectral frequencies in the frequency range deviating from the previously determined number are determined. Preferably, the frequency range is greater than the previously determined frequency range. A quotient of the frequency range and the number results in the target spectral frequency step. This step is a modified third step. The fourth step is then performed again. A spectral maximum is then searched for in the fine frequency spectrum. If a spectral maximum is found, a fine spectral maximum frequency of the spectral maximum in the frequency domain is determined and the sixth step is performed again. It is not necessary to perform the third, fourth and fifth steps again, as the target spectral frequency step has already been set and the distance is therefore determined with the accuracy of the target spectral frequency step.

In a further development of the above design, if a spectral maximum has not been found, the steps according to the above design are performed again. Preferably, the frequency range is increased.

In a third of the alternative designs, the second step, the third step, the fourth step, the fifth step and the sixth step are performed again. This implementation is preferably only performed if no spectral maximum has been found when performing the first alternative embodiment and/or the second alternative embodiment. This is because in the third alternative design, the second step is performed again, in which a coarse frequency spectrum of the mixed signal is determined, which means an additional energy requirement.

If a spectral maximum has been found in one of the alternative designs and the distance has been determined, then preferably the first design of the inventive method is performed again. If a spectral maximum has not been found in any of the alternative designs, then the inventive method according to claim 1 is performed again. Thus, the inventive method is performed continuously and the radar device performing the inventive method is in a continuous operation.

In a further design of the inventive method, the frequency range and the number of spectral frequencies are determined with additional consideration of the previously determined distance. By additionally taking into account the previously determined distance, the frequency range is determined more closely around the actual spectral maximum frequency.

In a further design of the inventive method, a speed of a change in the previously determined distance is determined and the frequency range and the number of spectral frequencies are determined with additional consideration of the speed. By additionally taking the speed into account, the frequency range is determined more closely around the actual maximum spectral frequency.

In one design of the inventive method, the coarse frequency spectrum of the mixed signal is determined using an FFT. An FFT is suitable for determining the coarse frequency spectrum, as it generates a frequency spectrum in a frequency range between 0 and f_{S}/N. The spectral maximum, which represents the distance, will in any case lie in this frequency range. Thus, the use of the FFT allows a rough determination of the actual spectral maximum frequency of the spectral maximum, i.e. the coarse spectral maximum frequency.

In a further design, the coarse frequency range is determined using a bandwidth of the emission signal and/or a predetermined maximum speed between the radar device and the object.

In a further design, the emission signal is generated at a frequency that increases or decreases over an emission interval Δt. The emission interval is a duration in which the emission signal is transmitted. Preferably, the increasing frequency has a constant slope over the time in the emission interval. This emission signal can be generated in a simple manner and results in a high accuracy in determining the distance of the object.

In a further development of the above design of the inventive method, the frequency range is limited by an upper limit frequency fₘₐₓ and a lower limit frequency fₘᵢₙ. The upper limit frequency fₘₐₓ is determined as being proportional to a product of a predetermined maximum distance dₘₐₓ between the radar device and the object, the emission interval Δt and the reciprocal of the speed of light 1/c₀. The speed of light is a vacuum speed of light. The following therefore applies:

$${r}_{max} ∝ {d}_{max} \cdot Δ t \cdot \frac{1}{{c}_{0}}$$

Preferably, the upper limit frequency is determined as a product of the maximum distance, the emission interval, the reciprocal of the speed of light and a factor of two. The following therefore applies:

$${f}_{max} = {d}_{max} \cdot Δ t \cdot \frac{1}{{c}_{0}} \cdot 2$$

In this design, the lower limit frequency fₘᵢₙ is determined as being proportional to a product of a predetermined minimum distance dₘᵢₙ between the radar device and the object, the emission interval Δt and the reciprocal of the speed of light 1/c₀. The following therefore applies:

$${f}_{min} ∝ {d}_{min} \cdot Δ t \cdot \frac{1}{{c}_{0}}$$

Preferably, the lower limit frequency is determined as a product of the minimum distance, the emission interval, the reciprocal of the speed of light and a factor of two. The following therefore applies:

$${f}_{m i n} = {d}_{m i n} \cdot Δ t \cdot \frac{1}{{c}_{0}} \cdot 2$$

The maximum distance dₘₐₓ and the minimum distance dₘᵢₙ are specified to the radar device, i.e. the controller, as already mentioned. These depend on the respective application of the inventive method and can be easily determined. They are preferably stored in the controller.

In a further development of the above design, a change in distance Δd between the radar device and the object is determined by first determining a sum of a division of the speed of light c₀ by twice a bandwidth B of the emission signal and a product of a predetermined maximum speed vₘₐₓ between the radar device and the object and a time interval T between two successive emissions of the emission signal. The following therefore applies:

$$Δ d = \frac{{c}_{0}}{2 B} + {v}_{ma x} \cdot T$$

Furthermore, the maximum distance dₘₐₓ is determined by adding a product of a weighting factor k and the change in distance Δd to a previously determined distance d between the radar device and the object. The following therefore applies:

$${d}_{m ax} = d + k \cdot Δ d$$

Furthermore, the minimum distance dₘᵢₙ is determined by subtracting a product of the weighting factor k and the change in distance Δd from the previously determined distance d between the radar device and the object. The following therefore applies:

$${d}_{m ax} = d - k \cdot Δ d$$

Further, the weighting factor is selected between one and two. The maximum speed vₘₐₓ is specified for the radar device, i.e. the controller. This depends on the respective application of the inventive method and can be easily determined.

Various objects are achieved not only by the inventive methods described above, but also by the radar device designed to perform one of the inventive methods described above. For this purpose, it has in particular a controller and an antenna device.

In one design of the radar device, the radar device is a field device. Preferably, it is a level measuring device or a level switch. If the radar device is a level measuring device or a level switch, then the object is a medium whose fill level in a container is to be measured or monitored. The distance then corresponds to the fill level of the medium in the container. The inventive method is particularly suitable for applications in level measuring devices and level switches, as a fill level changes only slowly in relation to the time interval T between two successive emissions of the emission signal.

In a further design, the radar device has a current loop interface and is further designed for communication via the current loop interface and for exclusive supply with electrical energy via the current loop interface from a current loop. The inventive method is particularly suitable for radar devices of this design. This is because the power that can be drawn from a current loop is so low that it is certainly not sufficient for performing the method known from the prior art. In the inventive method described here, the energy for each determination of the distance is lower during continuous operation, so that reliable operation is guaranteed when the radar device is supplied exclusively from a current loop. In a preferred further development, the radar device is a previously described level measuring device or a previously described level switch.

In detail, there are a large number of possibilities for designing and further developing the inventive method and the radar device. For this purpose, reference is made to the following description of preferred embodiments in conjunction with the accompanying drawing.

### BRIEF DESCRIPTION OF THE DRAWINGS

FIG. 1 shows a radar device and an object in accordance with aspects of the invention.

FIG. 2 shows a flowchart of a method in accordance with aspects of the invention.

FIG. 3 shows emission signals and reflection signals over time in accordance with aspects of the invention.

FIG. 4a shows a coarse frequency spectrum of a mixed signal in accordance with aspects of the invention.

FIG. 4b shows a fine frequency spectrum of the mixed signal in accordance with aspects of the invention.

### DETAILED DESCRIPTION OF THE INVENTION

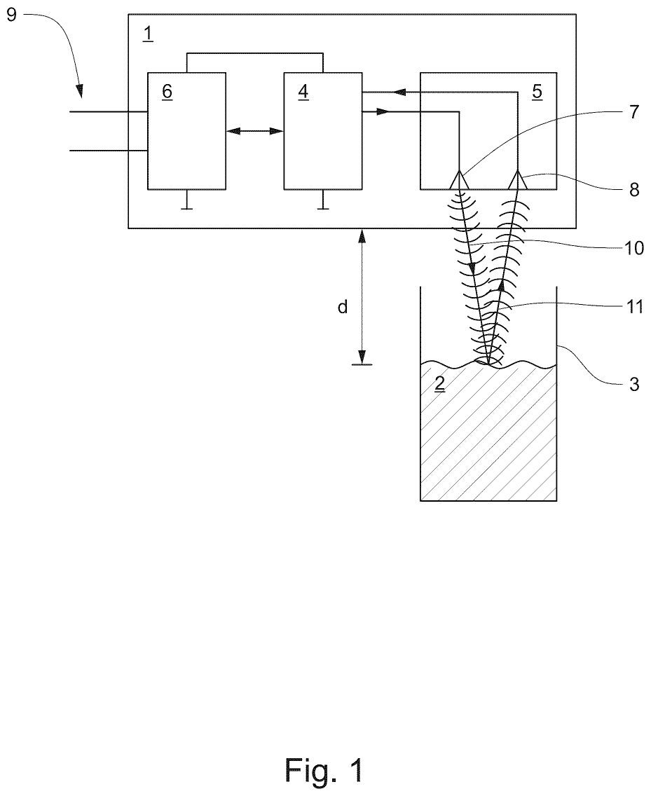

FIG. 1 shows a radar device 1 and an object 2. In this embodiment, the radar device 1 is a level measuring device and the object 2 is a medium with a fill level in a container 3. The radar device 1 is designed to continuously determine a distance d between the radar device 1 and the object 2. In this embodiment, the distance d corresponds to the fill level of the medium in the container 3.

The radar device 1 has a controller 4, an antenna device 5 and a current loop interface 6. The antenna device 5 has a transmitting antenna 7 and a receiving antenna 8. The radar device 1 is designed for communication via the current loop interface 6 and for exclusive supply with electrical energy via the current loop interface 6 from a current loop. It is connected to a current loop 9 via the current loop interface 6. During operation of the radar device 1, it communicates via the current loop 9 and is supplied with electrical energy exclusively from this loop. The communication includes, in particular, continuous transmission of the distance d.

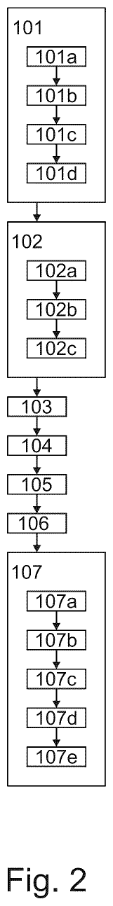

The controller 4, and thus also the radar device 1, is designed to perform the method described below. FIG. 2 shows a flowchart of the method performed by the controller 4.

In a first step 101, the following sub-steps are performed:

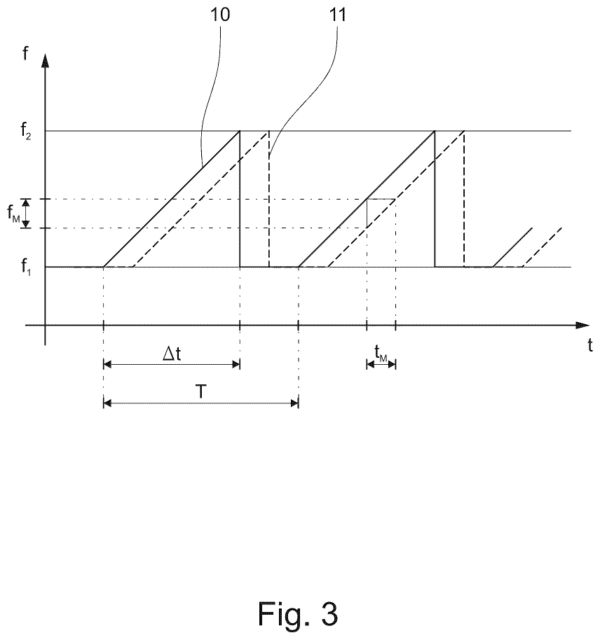

In a first sub-step 101a of the first step 101, a frequency-modulated emission signal 10 is generated. FIG. 3 shows the emission signal 10 over time. The emission signal 10 is generated over an emission interval Δt with an increasing frequency f. The frequency f increases from f₁ to f₂. The increasing frequency f has a constant slope in the emission interval Δt. The frequency f lies in a radar frequency range. The emission signal 10 has a bandwidth B=f₂−f₁.

In a second sub-step 101b, the emission signal 10 is transmitted via the transmitting antenna 7 of the antenna device 5. FIG. 1 shows a propagation of the emission signal 10, which is an electromagnetic wave, in the direction of the object 2.

In a third sub-step 101c, the receiving antenna 8 of the antenna device 5 receives a reflection signal 11 caused by the emission signal 10 at the object 2, which is also an electromagnetic wave. FIG. 1 shows a propagation of the reflection signal 10 in the direction of the radar device 1 and FIG. 3 shows the reflection signal 10 over time.

In a fourth sub-step 101d, the emission signal 10 and the reflection signal 11 are mixed together to form a mixed signal. The reflection signal 11 is delayed relative to the emission signal 10 by a delay time t_{M}, see FIG. 3. The mixed signal has a beat with a beat frequency f_{M}. The beat frequency f_{M} and the delay time t_{M} correspond to each other. Thus, the actual distance d can be determined exactly from the beat frequency f_{M} using an additional speed of light c₀.

In a second step 102, the following sub-steps are performed:

In a first sub-step 102a of the second step 102, a coarse frequency spectrum of the mixed signal in a coarse frequency range is determined using an FFT. Fourier coefficients S_{k,FFT} are determined according to the following formula:

$${S}_{k , FFT} = {\sum }_{n = 0}^{N - 1} {s}_{n} {e}^{- 2 π j \frac{n}{N} k} with k = 0 , 1 , 2 , … , N - 1$$

In the above formula, k is a running index and sₙ are time-discrete measured values of the mixed signal. These are also measured by controller 4. N is the number of measured values.

The Fourier frequencies fₖ,FFT associated with the Fourier coefficients S_{k,FFT} are determined according to the following formula:

$${f}_{k , FFT} = \frac{k}{N} {f}_{s} with k = 0 , 1 , 2 , … , \frac{N}{2}$$

In the formula, fₛ is a sampling frequency with which the measured values sₙ of the mixed signal are sampled by the controller 4 in discrete time.

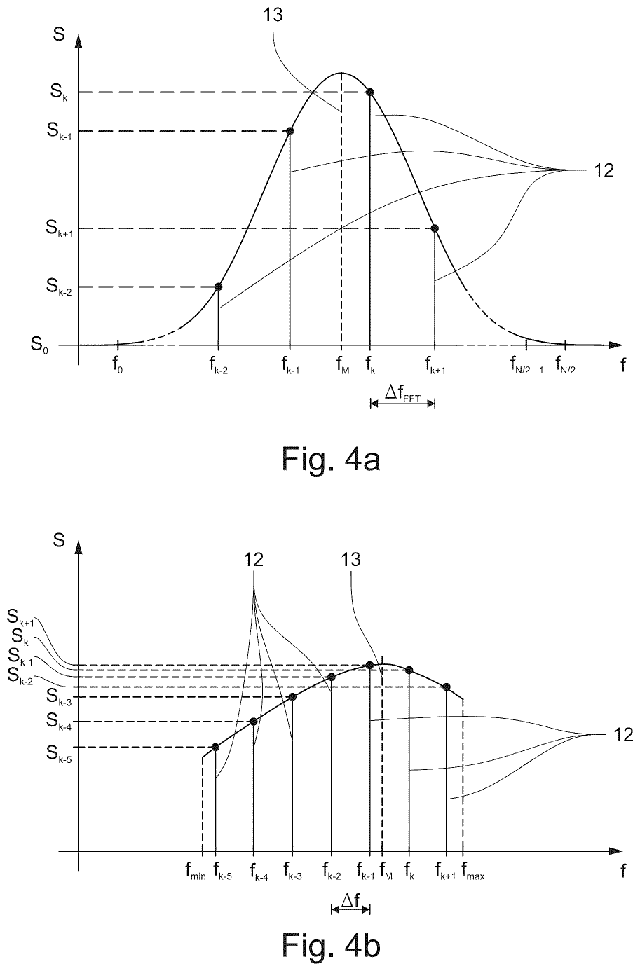

FIG. 4a schematically shows spectral lines 12 of the coarse frequency spectrum determined using the FFT. Each of the spectral lines 12 is determined by a Fourier coefficient S_{k,FFT}, entered there as Sₖ, and its associated Fourier frequency f_{k,FFT}, entered there as fₖ. A coarse spectral frequency step of two consecutive spectral lines is Δf_{FFT}=fₛ/N. The spectral line 12 with the lowest Fourier frequency is at a lower limit frequency f_{min,FFT}=f₀=0 and the spectral line 12 with the highest Fourier frequency results for k=N/2 and is at an upper limit frequency of f_{max,FFT}=f_{N/2}=fₛ/2.

The coarse frequency range extends from the lower limit frequency f_{min,FFT} to the upper limit frequency f_{max,FFT}. The coarse frequency spectrum basically has the shape of a Gaussian bell curve over the frequency.

In a second sub-step 102b, a spectral maximum 13 is determined in the coarse frequency spectrum. The determination shows that the spectral maximum 13 lies between the spectral line 12 with the Fourier frequency f_{k-1,FFT} and the spectral line 12 with the Fourier frequency fₖ,FFT.

In a third sub-step 102c, a coarse spectral maximum frequency of the spectral maximum 13 in the coarse frequency range is determined. The determination shows that the Fourier frequency f_{k,FFT} is closest to the spectral maximum 13. The coarse spectral maximum frequency is therefore f_{k,FFT}.

In a third step 103, a frequency range as narrow as possible around the coarse spectral maximum frequency f_{k,FFT} is determined on the one hand and a number M of spectral frequencies in the frequency range is determined on the other hand. The frequency range is limited by a lower limit frequency fₘᵢₙ and an upper limit frequency fₘₐₓ. In this embodiment, fₘᵢₙ=f_{k-1,FFT} and fₘₐₓ=f_{k,FFT}. The spectral maximum 13 is located in the frequency range. The narrowness of the frequency range around the coarse spectral maximum frequency f_{k,FFT} is limited in one resolution by the spectral frequency step Δ_{fFFT}. Furthermore, a quotient is formed from the frequency range (fₘₐₓ−fₘᵢₙ) and the number M. This is a target spectral frequency step Δf. The following therefore applies:

$$Δ f = \frac{{r}_{m ax} - {r}_{m i n}}{M}$$

The number M is determined in such a way that the target spectral frequency step Δf results in an accuracy of the determination of the distance d which is sufficient for the application.

In a fourth step 104, a fine frequency spectrum of the mixed signal in the frequency range, i.e. between fₘᵢₙ and fₘₐₓ, with the number M of spectral frequencies is determined using a CZT. Fourier coefficients Sₖ are determined according to the following formula:

$${S}_{k} = {\sum }_{n = 0}^{N - 1} {s}_{n} {A}^{- n} {W}^{nk} with k = 1 , 2 , … , M - 1$$

In the above formula, k is a running index, sₙ is again the discrete-time measured values of the mixed signal and N is again the number of measured values. The running index k in connection with the FFT is different from the running index k in connection with the CZT.

A in the above formula is determined according to the following formula:

$$A = {e}^{- 2 π j \frac{{f}_{m i n}}{{f}_{s}}}$$

W in the above formula is determined according to the following formula:

$$W = {e}^{- 2 π j \frac{1}{M} \frac{{f}_{m ax} - {f}_{m i n}}{{f}_{s}}}$$

fₛ is the known sampling frequency. FIG. 4b schematically shows spectral lines 12 of the fine frequency spectrum determined using the CZT.

In a fifth step 105, a fine spectral maximum frequency of the spectral maximum 13 is determined in the frequency domain. The determination determines that the frequency fₖ₋₁ is closest to the spectral maximum 13. The fine spectral maximum frequency is therefore fₖ₋₁.

In a sixth step 106, the distance d between the radar device 1 and the object 2 is determined using the fine spectral maximum frequency fₖ₋₁. The spectral maximum 13 represents the beat. Ideally, the fine spectral maximum frequency fₖ₋₁ corresponds to the beat frequency f_{M}. One aim of the method is to determine the fine spectral maximum frequency fₖ₋₁ sufficiently close to the beat frequency f_{M} for the application.

In a seventh step 107, the following sub-steps are performed:

In a first sub-step 107a of the seventh step 107, the first step 101 is performed again, wherein the first sub-step 101a is preferably omitted.

In a second sub-step 107b, a frequency range, which is again limited by an upper limit frequency fₘₐₓ and a lower limit frequency fₘᵢₙ, and a number M of spectral frequencies in the frequency range are again determined, wherein, taking into account the previously determined fine spectral maximum frequency fₖ₋₁, a quotient of the frequency range and the number M again results in the target spectral frequency step Δf.

In a third sub-step 107c, the fourth step 104 is performed again.

In a fourth sub-step 107d, a spectral maximum 13 is searched for in the fine frequency spectrum and is also found here.

In a fifth sub-step 107e, a fine spectral maximum frequency of the spectral maximum 13 in the frequency domain is determined and the sixth step 106 is performed again.

In the seventh step 107, the method is continuously performed by the radar device 1 and each execution provides the current distance d between the radar device 1 and the object 2, i.e. in this case the current fill level of the medium in the container 3.

After the first determination of the distance d between the radar device 1 and the object 2, the frequency range, which, as already indicated above, is limited by the upper limit frequency fₘₐₓ and the lower limit frequency fₘᵢₙ, is determined as follows.

The upper limit frequency is determined according to the following formula:

$${f}_{m ax} = {d}_{m ax} \cdot Δ t \cdot \frac{1}{{c}_{0}} \cdot 2$$

The lower limit frequency is determined according to the following formula:

$${f}_{m i n} = {d}_{m i n} \cdot Δ t \cdot \frac{1}{{c}_{0}} \cdot 2$$

In the above two formulas, dₘₐₓ is a maximum distance and dₘᵢₙ is a minimum distance between the radar device 1 and the object 2. In this embodiment, these correspond to a maximum and minimum fill level of the medium, i.e. the object 2, in the container 3.

The maximum distance dₘₐₓ is determined using the previously determined distance d according to the following formula:

$${d}_{m ax} = d + k \cdot Δ d$$

The minimum distance dₘᵢₙ is also determined using the previously determined distance d according to the following formula:

$${d}_{m ax} = d - k \cdot Δ d$$

In the above two formulas, Δd is a distance change between the radar device 1 and the object 2 and k is a weighting factor and is chosen between one and two.

The change in distance Δd is determined according to the following formula:

$$Δ d = \frac{{c}_{0}}{2 B} + {v}_{ma x} \cdot T$$

In the above formula, B is the bandwidth of the emission signal 10, vₘₐₓ is a predetermined maximum speed between the radar device and the object, and T is a time interval between two successive emitting of the emission signal 10.

In an alternative design, the determination of the frequency range described above after the first determination of the distance d is also used for the first determination of the distance d, since an initial value for the distance d is specified.

### REFERENCE NUMBERS

1 Radar device
2 Object
3 Container
4 Controller
5 Antenna device
6 Current loop interface
7 Transmitting antenna
8 Receiving antenna
9 Current loop
10 Emission signal
11 Reflection signal
12 Spectral line
13 Spectral maximum

What is claimed is:

1. A method of using a radar device for determining a distance between the radar device and an object by means of frequency-modulated continuous wave radar, the method comprising:
a first step comprising generating and emitting a frequency-modulated emission signal, receiving a reflection signal caused by the emission signal at the object, and mixing the emission signal and the reflection signal with one another to form a mixed signal,
a second step comprising determining a coarse frequency spectrum of the mixed signal in a coarse frequency range, a spectral maximum in the coarse frequency spectrum, and a coarse spectral maximum frequency of the spectral maximum in the coarse frequency range,
a third step comprising determining, based on the coarse spectral maximum frequency, a frequency range and a number of spectral frequencies in the frequency range, wherein a quotient of the frequency range and the number spectral frequencies results in a target spectral frequency step,
a fourth step comprising determining, using a chirp Z-transform, a fine frequency spectrum of the mixed signal in the frequency range with the number of spectral frequencies,
a fifth step comprising determining a fine spectral maximum frequency of a spectral maximum in the frequency range, and
a sixth step comprising determining a distance between the radar device and the object using the fine spectral maximum frequency.

2. The method according to claim 1, further comprising:
performing the first step again,
determining again, based on the previously determined fine spectral maximum frequency, a frequency range and a number of spectral frequencies in the frequency range, wherein a quotient of the frequency range and the number of spectral frequencies gives the target spectral frequency step,
performing the fourth step again,
searching for a spectral maximum in the fine frequency spectrum, and
if a spectral maximum is found in the fine frequency spectrum, then determining a fine spectral maximum frequency of the spectral maximum in the frequency range and performing the sixth step again.

3. The method according to claim 2, wherein, if a spectral maximum is not found, then further comprising:
performing the first step again,
determining again, based on the previously determined fine spectral maximum frequency, a frequency range and a number of spectral frequencies in the frequency range, wherein a quotient of the frequency range and the number of spectral frequencies results in a spectral frequency step greater than the target spectral frequency step,
performing the fourth step again,
searching for a spectral maximum in the fine frequency spectrum, and
if a spectral maximum found in the fine frequency spectrum, then determining a fine spectral maximum frequency of the spectral maximum in the frequency range and performing the third step, the fourth step, the fifth step, and the sixth step again.

4. The method according to claim 3, wherein, if a spectral maximum is not found, then preforming the steps of claim 3 again and increasing the frequency range.

5. The method according to claim 2, wherein, if a spectral maximum is not found, then further comprising:
performing the first step again,
determining, based on the previously determined fine spectral maximum frequency, a frequency range deviating from the previously determined frequency range and a number of spectral frequencies in the frequency range deviating from the previously determined number of spectral frequencies, wherein a quotient of the frequency range and the number of spectral frequencies gives the target spectral frequency step,
performing the fourth step again,
searching for a spectral maximum in the fine frequency spectrum,
wherein if a spectral maximum is found in the fine frequency spectrum, then determining a fine spectral maximum frequency of the spectral maximum in the frequency domain and performing the sixth step again.

6. The method according to claim 5, wherein, if a spectral maximum is not found, then performing the steps according to claim 5 again and increasing the frequency range.

7. Method according to claim 2, wherein, if a spectral maximum has not been found in the in the fine frequency spectrum, then performing the second step, the third step, the fourth step, the fifth step, and the sixth step again.

8. The method according to claim 2, wherein the determination of the frequency range and the number of spectral frequencies is carried out additionally based on the previously determined distance.

9. The method according to claim 2, further comprising determining a speed of a change of the previously determined distance and the determination of the frequency range and the number of spectral frequencies is carried out additionally based on the speed of change.

10. The method according to claim 1, wherein the coarse frequency spectrum is determined using an FFT.

11. The method according to claim 1, wherein the coarse frequency range is determined using a bandwidth of the emission signal and/or a predetermined maximum velocity between the radar device and the object.

12. The method according to claim 1, wherein the emission signal is generated with a frequency increasing or decreasing over an emission interval.

13. The method according to claim 12, wherein the frequency has a constant slope over time in the emission interval.

14. The method according to claim 12, wherein:
the frequency range is limited by an upper limit frequency and a lower limit frequency,
the upper limit frequency is determined as proportional to a product of a predetermined maximum distance between the radar device and the object, the emission interval, and the reciprocal of the speed of light, and
the lower limit frequency is determined as proportional to a product of a predetermined minimum distance between the radar device and the object, the emission interval, and the reciprocal of the speed of light.

15. The method according to claim 14, wherein:
the upper limit frequency is determined as a product of the maximum distance, the emission interval, the reciprocal of the speed of light, and a factor of two, and
the lower limit frequency is determined as a product of the minimum distance, the emission interval, the reciprocal of the speed of light, and a factor of two.

16. The method according to claim 14, wherein:
a change in distance between the radar device and the object is determined by determining a sum of a division of the speed of light by twice a bandwidth of the emission signal and a product of a predetermined maximum speed between the radar device and the object and a time interval between two successive emissions of the emission signal,
the maximum distance is determined by adding a product of a weighting factor and the change in distance to a previously determined distance between the radar device and the object,
the minimum distance is determined by subtracting a product of the weighting factor and the change in distance from the previously determined distance between the radar device and the object, and
the weighting factor is selected between one and two.

17. A radar device for determining a distance between the radar device and an object by means of frequency-modulated continuous wave radar, wherein the radar device is configured to perform the method according to claim 1.

18. The radar device according to claim 17, wherein the radar device is a field device.

19. The radar device according to claim 18, wherein the radar device is a level measuring device or a level switch.

20. The radar device according to claim 17, wherein the radar device has a current loop interface and is designed for communication via the current loop interface and for exclusive supply with electrical energy via the current loop interface from a current loop.
